(19) United States
(12) Patent Application Publication
(10) Pub. No.: US 2008/0219280 A1
(43) Pub. Date: Sep. 11, 2008

(54) Method and apparatus for flexible FXS port utilization in a telecommunications device

(76) Inventors: Daniel T. Smires, Freehold, NJ (US); Frank J. Amato, Berkeley Heights, NJ (US)

Correspondence Address: VONAGE, 23 MAIN STREET, HOLMDEL, NJ, 07733, US

(21) Appl. No.: 12/011,491

(22) Filed: Jan. 25, 2008

Related U.S. Application Data
(60) Provisional application No. 60/897,500, filed on Jan. 26, 2007.

(51) Int. Cl. H04L 12/56

(52) U.S. Cl. 370/419

(57) ABSTRACT

An apparatus for flexible FXS port utilization includes a switch adapted for connection to a plurality of Internet Protocol (IP) based communication lines, a subscriber line interface card (SLIC) connected to the switch and having a single FXS port and an IP based handset connected to the switch. The switch may be a softswitch with switching operations executed by a network processor adapted for connection between an external IP signal source and the switch. A method of the invention includes providing a utilization status of the single FXS port and performing an automated switching operation at least the SLIC; based on and in response to a desired port utilization status initiated remotely from the communication device.

The application claims the benefit of U.S. Provisional Application No. 60/897,500 filed Jan. 26, 2007.

### FIELD OF THE INVENTION

The invention is related to the field of telecommunication devices and services and more specifically, the invention is directed to a method and apparatus for switching between different types of port utilization in a telecommunication device.

### BACKGROUND OF THE INVENTION

Voice over IP (VoIP) is a recent technological development in the field of telecommunications that is utilized to transmit voice conversations over a data network using the Internet Protocol (IP). Entities (e.g., businesses or individuals) implement VoIP by purchasing and installing the necessary equipment (e.g., one or more Customer Premise Equipment (CPE) devices) to access a VoIP service provider and activating this telecommunication service. Since VoIP is a relatively new technology in terms of its commercial penetration, it has yet to completely supplant the existing and traditional telecommunications system more commonly referred to as the Public Switched Telephone Network (PSTN) or Plain Old Telephone Service (POTS). Accordingly, there is a huge amount of existing PSTN equipment that entities are reluctant to completely abandon for economic and strategic reasons. To further complicate matters, VoIP-based devices and existing PSTN-based devices are not compatible, thus, they require intermediate components or interfaces in order to function with each other.

One example of the incompatibility and the problems associated with same is depicted in FIG. 1. Specifically, FIG. 1 depicts a VoIP-based CPE device 100 that is used in accordance with IP signaling to carry voice communications over a data network (such as a corporate intranet, the Internet and the like). The CPE device 100 includes a network processor 102 adapted for connection to an IP signaling source such as but not limited to a router (not shown). The network processor 102 has the necessary combination of hardware and software in order to convert the IP signals (e.g., packets) into one or more voice lines (depicted as lines 112₁ and 112₂ for a “two-line IP phone”). One of the voice lines is connected (via the network processor 102) to a handset portion 114 of the CPE device 100 to allow for normal VoIP calling operations. Additionally, one or more of the voice lines 112 is also connected to a Subscriber Line Interface Circuit (SLIC) 104 which performs the necessary operations to convert the IP signals along the voice lines 112 into analog signals. Such analog signals conform to PSTN communications protocols to allow PSTN-based devices to perform calling operations over the IP network. Specifically, output ports (better known as FXS ports) 116₁ and 116₂ of the SLIC 104 are connected to one or more PSTN device connection points 106 which in one example are known in the art as RJ11 telephone jacks. The analog signals travel from the FXS ports 116 to the RJ11 telephone jacks 106₁ and 106₂ to their respective PSTN devices such as a PSTN telephone 108 and a PSTN fax machine 110.

Such a CPE device 100 is well suited for performing communication operations for VoIP lines, but it has been found that such a device has a higher than desirable manufacturing cost. This condition is due to the complexity of having two FXS ports on the SLIC 104 as well as the extra RJ11 jack, magnetic devices and other discrete components necessary to create the two separate analog voice lines. Therefore, there is a need in the art for a method and apparatus for improving the utilization of a single FXS port SLIC (and the CPE device associated therewith) so as to reduce the unit cost of the CPE device.

### SUMMARY OF THE INVENTION

The disadvantages associated with the prior art are overcome by a method and apparatus for flexible FXS port utilization. The invention provides an apparatus that includes a switch adapted for connection to a plurality of Internet Protocol (IP) based communication lines, a subscriber line interface card (SLIC) connected to the switch and having a single FXS port and an IP based handset connected to the switch. The switch may be a softswitch. In such an embodiment, switching operations of the softswitch are executed by a network processor connected to the switch. The network processor is adapted for connection between an external IP signal source and the switch. The network processor converts IP signals into the plurality of IP based communication lines. The plurality of IP based communication lines are at least two VoIP lines in one embodiment of the invention. The apparatus also includes a means for external communication device connection connected to the SLIC such as an RJ11 telephone jack.

A method of the invention includes the steps of providing a utilization status of the single FXS port and performing an automated switching operation at at least the SLIC; based on and in response to a desired port utilization status initiated remotely from the communication device. The step of providing includes relaying utilization status information of the FXS port device found in a configuration file. The utilization status information is relayed to one selected from the group consisting of a communication service subscriber and a communication service provider. The desired port utilization status initiated remotely from the communication device may occur by an activity selected from the group consisting of a communication service provider providing new configuration file information to the communication device and a communication service subscriber providing new configuration file information to his communication device. The automated switching operation changes switch connection points of at least one switching point in the communication device based on changes to a configuration file therewithin.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a schematic view of an existing telecommunication device having at least two FXS ports on a SLIC;

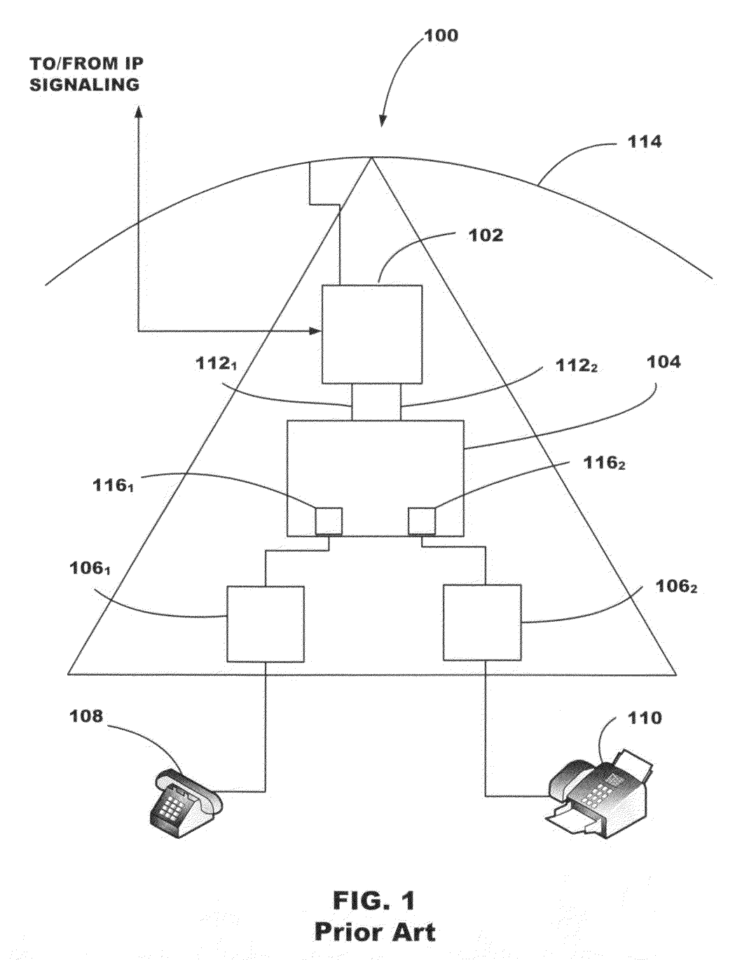

FIG. 2 depicts a schematic view of an apparatus capable of flexible FXS port utilization in accordance with the subject invention;

FIG. 3 depicts a series of method steps for performing flexible port utilization in accordance with the subject invention; and

FIG. 4 depicts a schematic diagram of a controller that may be used to practice the switching operations of the present invention.

To facilitate understanding, identical reference numerals have been used, where possible, to designate identical elements that are common to the figures.

### DETAILED DESCRIPTION

To achieve the desired objectives, the subject invention provides an apparatus for managing port utilization of a single FXS port SLIC and/or an integrated handset in a VoIP-based telecommunication device. The management is performed by intelligent switching of various internal termination points of the telecommunication device so that multiple VoIP communications streams are possible without the increased cost of equipment requiring more than one FXS port. Generally, the telecommunication device is an IP telephone, but other types of telecommunication devices are considered within the scope of the invention including but not limited to a VoIP-based cordless telephone and a VoIP-based corded telephone. In one embodiment of the invention, the telecommunication device is a two line VoIP telephone that is connected over an IP-based network such as (but not limited to) the Internet and is capable of transmitting and receiving communications from other telecommunication devices such as other VoIP telephones and PSTN devices such as fax machines, POTS phones and related PSTN-based services and the like.

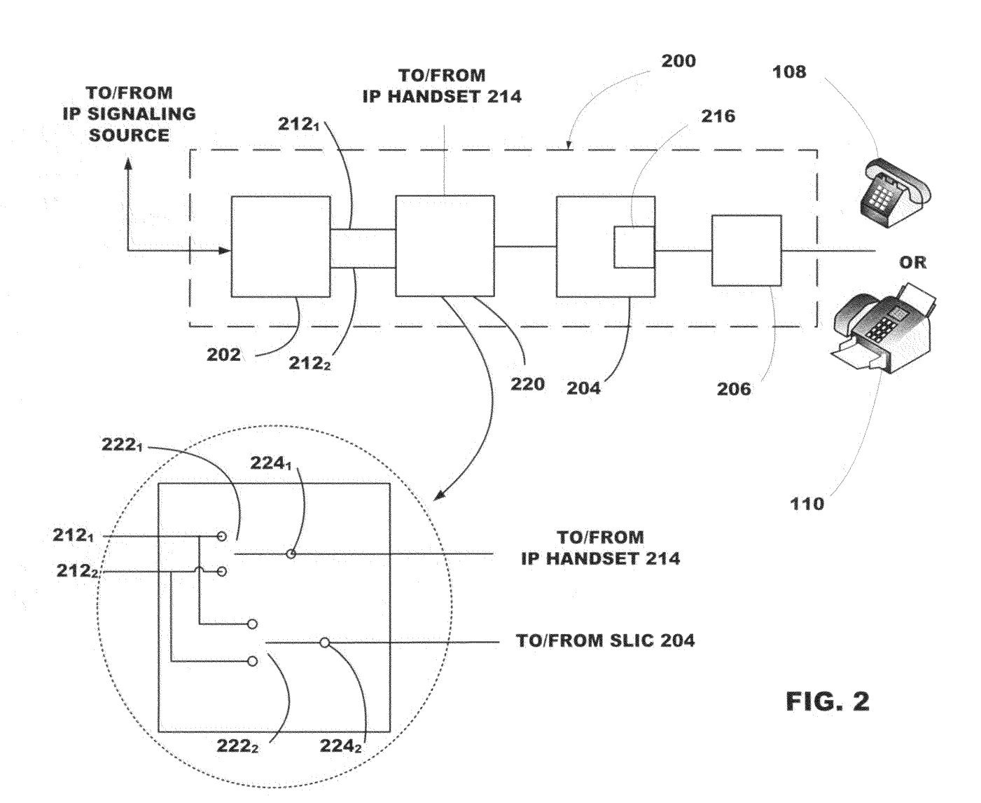

The apparatus in accordance with the subject invention is generally seen in FIG. 2 which depicts a schematic diagram of an IP-based telecommunication device or CPE 200. Similar to CPE device 100, the inventive CPE device 200 includes a network processor 202 adapted for connection to an IP signaling source such as but not limited to a router (not shown). The network processor 202 has the necessary combination of hardware and software in order to convert the IP signals (e.g., packets) into one or more voice lines 212. In the specific embodiment shown, two such voice lines 212₁, 212₂ are provided (i.e., a “two-line IP phone”).

The two voice lines 212₁ and 212₂ form the input to a logical switch 220. The term “logical switch” is described in greater detail below and is defined as an operator for selecting a connection point between at least one of the voice lines 212 and an output of the telecommunication device 200. As a result of a first switching operation performed by the logical switch 220, a handset component 214 (similar in functionality to handset component 114 of telecommunication device 100) is connected to one of the voice lines 212 of the telecommunication device 200. As a result of a second switching operation, a SLIC 204 is connected to one of the voice lines 212. The SLIC 204 is similar in function and purpose to SLIC 104 of telecommunication device 100 as described above; however, it is provided with only one FXS port 216. Further, the inventive telecommunication device 200 includes only one connection point 206 (similar to connection point 106 of telecommunication device 100) connected to the one FXS port 216. Accordingly, analog signals from the SLIC 204 travel from the FXS port 216 to the (exemplary) RJ11 telephone jack 206 to a PSTN device. Examples of such PSTN devices are selected from the group consisting of a PSTN telephone 108 and a PSTN fax machine 110.

The term “logical switch” with respect to element 220 of the telecommunication device 200 is used to convey the concept that this element is not necessarily a discrete switch as understood in terms of hardware devices. In other words, element 220 is considered a “softswitch” as is known in the art which performs switching operations of passing signals from a first plurality of points to a second plurality of points as a function of coded instructions rather than a physical manipulation of discrete components that open and close paths between such points. In one embodiment of the invention, switching operations are executed by instructions being passed from one portion to another portion of the network processor 202.

As an example of the possible switching operations, a logical representation of switching points available to the logical switch 220 is depicted in the blow-up circle of said switch 220 in FIG. 2. Specifically, one or more voice lines 212₁ and 212₂ from the network processor 202 define a first switching point 222₁ and a second switching point 222₂ respectively. That is, the one or more voice lines are provided as parallel inputs to the first switching point 222₁ and a second switching point 222₂. When switching operations in accordance with the subject invention require connection of the handset component 214, the softswitch 220 makes a connection between first switching point 222₁ and a first terminating point 224₁. Switching operations to the first terminating point 224₁ provide the appropriate signaling to an IP-based communication device such as but not limited to one selected from the group consisting of a VoIP cordless telephone and a VoIP corded telephone. This listing is exemplary in nature and not limited to such devices as those skilled in the art can connect other such devices to achieve the same goals. When switching operations in accordance with the subject invention require connection to a PSTN device, the softswitch 220 makes a connection between second switching point 222₂ and a second terminating point 224₂. Switching operations to the second terminating point 224₂ provide the appropriate signaling to the SLIC 204, output port (FXS port) 216 and connection point 206 for connection to a PSTN device such as but not limited to one selected from the group consisting of a PSTN telephone 108 and a PSTN fax machine 110.

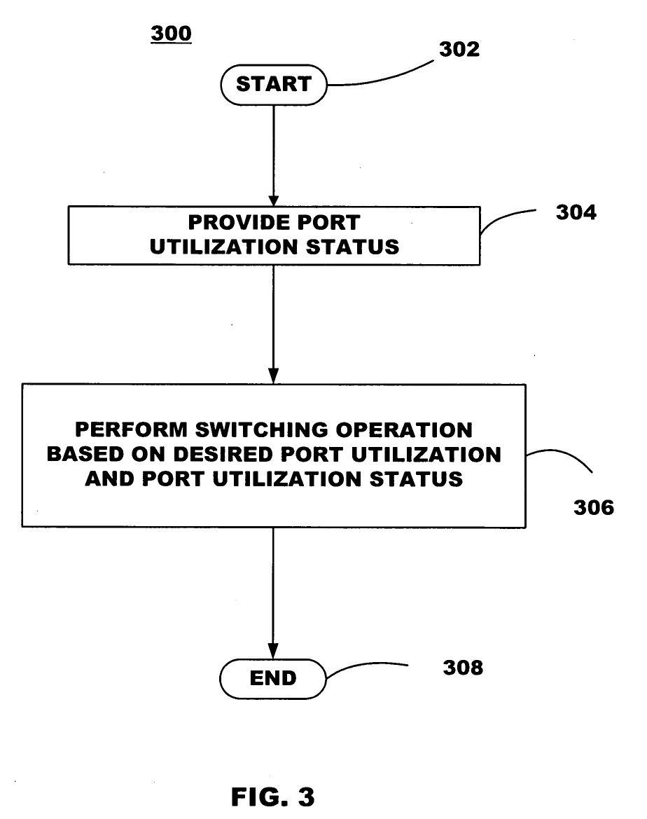

As discussed, softswitch 220 implements its switching operations by executing a set of instructions rather than by physical manipulation of contact points. FIG. 3 depicts a series of method steps 300 for performing telecommunication device port utilization (e.g., switching) in accordance with the subject invention. That is, the user of the CPE device 200 has a desired FXS and/or IP port utilization in mind (depending on the type of CPE device the customer has) prior to initiating a VoIP communication session. For example, in a default condition, the CPE device 200 is configured to have the first line 212₁ connected to both the IP handset 214 and the SLIC 204 so that one device from either connection point can be operated. This default condition may not be acceptable if the VoIP customer wants to conduct a VoIP telephone call (i.e., on the first line 212₁) and simultaneously send a fax (i.e., on the second line 212₂). Accordingly, the CPE device 200 performs switching operations in accordance with method 300 in order to achieve the desired port utilization.

In detail, the method 300 starts at step 302 and proceeds to step 304 where port utilization status is provided. That is, the CPE device 200 provides an indication of what the present statuses of the connections between the first switching point 222₁ and first termination point 224₁ and the second switching point 222₂ and second termination point 224₂ so that an appropriate switching operation can be performed in accordance with the desired port utilization. Such configuration would be indicated to either the VoIP subscriber or the VoIP provider. In one embodiment of the invention, the status of these connections is found in a configuration file in a memory of the CPE device 200. Such configuration file information can be read by one selected from the group consisting of a VoIP subscriber logged in to his customer account (i.e., via a web-based interface) and a VoIP provider technical support assistant reviewing the configuration file information remotely via customer account records.

At step 304, a switching operation of the FXS port is performed based on the desired port utilization and the previously provided utilization status. However, the instructions to perform the switching operation may come from a plurality of sources as follows. In a first embodiment of the invention, a VoIP provider technical support assistant, reviewing the configuration file information remotely via customer account records, provides new configuration file information to the CPE device 200 upon subscriber request. This operation changes the existing configuration file in the CPE device and subsequently changes the switch connection points of at least one of the switching points 222. In a second embodiment of the invention, a VoIP subscriber logs in to his customer account and provides new configuration file information to his CPE device 200. Similar to the first embodiment, this operation changes the existing configuration file in the CPE device and subsequently changes the switch connection points of at least one of the switching points 222.

Continuing from the example above, the new configuration file information instructs the softswitch 220 to maintain the connection at the first switching point 222₁ between the first line 212₁ and the IP handset 214 and to switch the second switching point 222₂ to connect the second line 212₂ to the SLIC 204. The switching operations could be reversed since the net result is the same (i.e., two different devices connected to two different lines). The VoIP subscriber logs into his customer account by methods selected from the group consisting of via a web-based interface and via an Interactive Voice Response (IVR) voice communication. The method then ends at step 308.

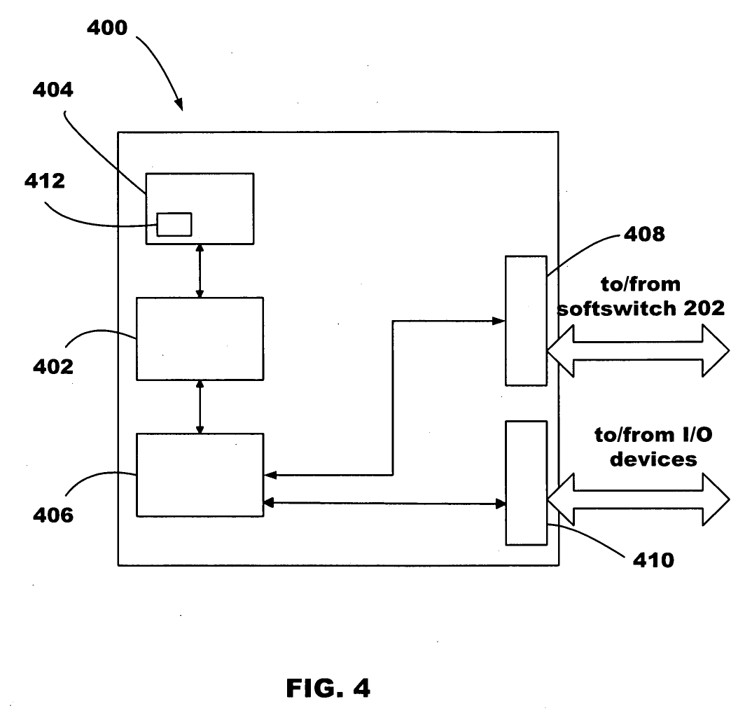

FIG. 4 depicts a schematic diagram of a controller 400 that may be used to practice the present invention. The controller 400 may be used to facilitate control of the CPE device 200 as described above. The controller 400 may be one of any form of a general purpose computer processor used in accessing an IP-based network such as a corporate intranet, the Internet or the like and in one embodiment of the invention is part of network processor 202. One skilled in the art will understand that other placements of the controller 400 are possible (e.g. remote placement in another component or section of the CPE device 200 or part of the components connected thereto via appropriate communication lines and protocols.

The controller 400 comprises a central processing unit (CPU) 402, a memory 404, and support circuits 406 for the CPU 402. The controller 400 also includes provisions 408/410 for connecting the controller 400 to an IP-based network and the CPE device 200 to facilitate execution of the switching process. The memory 404 is coupled to the CPU 402. The memory 404, or computer-readable medium, may be one or more of readily available memory such as random access memory (RAM), read only memory (ROM), floppy disk, hard disk, flash memory or any other form of digital storage, local or remote. The support circuits 406 are coupled to the CPU 402 for supporting the processor in a conventional manner. These circuits include cache, power supplies, clock circuits, input/output circuitry and subsystems, and the like. A software routine 412, when executed by the CPU 402, causes the controller 400 to perform switching operations in accordance with the present invention and is generally stored in the memory 404. The software routine 412 may also be stored and/or executed by a second CPU (not shown) that is remotely located from the hardware being controlled by the CPU 402.

The software routine 412 is executed when a preferred method of port utilization of the CPE device 200 is desired (i.e., when a second line 212₂ to PSTN device connection is desired to connect a PSTN fax machine 110 to a separate line. The software routine 412, when executed by the CPU 402, transforms the general purpose computer into a specific purpose computer (controller) 400 that controls the switching process. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 412 of the present invention is capable of being executed on computer operating systems including but not limited to Microsoft Windows 98, Microsoft Windows XP, Apple OS X and Linux. Similarly, the software routine 412 of the present invention is capable of being performed using CPU architectures including but not limited to Apple Power PC, Intel x86, Sun SPARC and Intel ARM.

While foregoing is directed to embodiments of the present invention, other and further embodiments of the invention may be devised without departing from the basic scope thereof, and the scope thereof.

What is claimed is:

1. An apparatus for flexible FXS port utilization comprising:
a switch adapted for connection to a plurality of Internet Protocol (IP) based communication lines;
a subscriber line interface card (SLIC) connected to the switch and having a single FXS port; and
an IP based handset connected to the switch.

2. The apparatus of claim 1 wherein the switch is a softswitch.

3. The apparatus of claim 2 wherein switching operations of the softswitch are executed by a network processor connected to the switch.

4. The apparatus of claim 1 further comprising a network processor adapted for connection between an external IP signal source and the switch.

5. The apparatus of claim 4 wherein the network processor converts IP signals from the external IP signal source into the plurality of IP based communication lines.

6. The apparatus of claim 5 wherein the plurality of IP based communication lines are at least two VoIP lines.

7. The apparatus of claim 1 further comprising a means for external communication device connection connected to the SLIC.

8. The apparatus of claim 7 wherein the means for external device connection is an RJ11 telephone jack.

9. A method of flexible FXS port utilization for a communication device having a switch adapted for connection to a plurality of Internet Protocol (IP) based communication lines; a subscriber line interface card (SLIC) connected to the switch and having a single FXS port and an IP based handset connected to the switch, the method comprising:
providing a utilization status of the single FXS port; and
performing an automated switching operation at least the SLIC; based on and in response to a desired port utilization status initiated remotely from the communication device.

10. The method of claim 9 wherein the step of providing further comprises relaying utilization status information of the FXS port device found in a configuration file.

11. The method of claim 10 wherein the utilization status information is relayed to one selected from the group consisting of a communication service subscriber and a communication service provider.

12. The method of claim 9 wherein the automated switching operation is performed by a softswitch.

13. The method of claim 12 wherein the automated switching operation of the softswitch is controlled by a network processor connected to the switch.

14. The method of claim 9 wherein the desired port utilization status initiated remotely from the communication device occurs by an activity selected from the group consisting of a communication service provider providing new configuration file information to the communication device and a communication service subscriber providing new configuration file information to his communication device.

15. The method of claim 9 wherein the automated switching operation changes switch connection points of at least one switching point in the communication device based on changes to a configuration file therewithin.

16. A computer readable medium storing a software program that, when executed by a computer, causes the computer to perform an operation of flexible FXS port utilization for a communication device having a switch adapted for connection to a plurality of Internet Protocol (IP) based communication lines; a subscriber line interface card (SLIC) connected to the switch and having a single FXS port and an IP based handset connected to the switch the operation comprising:
providing a utilization status of the single FXS port; and
performing an automated switching operation at least the SLIC; based on and in response to a desired port utilization status initiated remotely from the communication device.

17. The computer readable medium of claim 16 wherein the step of providing further comprises relaying utilization status information of the FXS port device found in a configuration file.

18. The computer readable medium of claim 17 wherein the utilization status information is relayed to one selected from the group consisting of a communication service subscriber and a communication service provider.

19. The computer readable medium of claim 16 wherein the automated switching operation is performed by a softswitch.

20. The computer readable medium of claim 19 wherein the automated switching operation of the softswitch is controlled by a network processor connected to the switch.

21. The computer readable medium of claim 16 wherein the desired port utilization status initiated remotely from the communication device occurs by an activity selected from the group consisting of a communication service provider providing new configuration file information to the communication device and a communication service subscriber providing new configuration file information to his communication device.

22. The computer readable medium of claim 16 wherein the automated switching operation changes switch connection points of at least one switching point in the communication device based on changes to a configuration file therewithin.
